(19) United States
(12) Patent Application Publication
(10) Pub. No.: US 2008/0205960 A1
(43) Pub. Date: Aug. 28, 2008

(54) Keyboard layout for one-handed touch-typing

(75) Inventor: Shakoor N. Siddeeq, Indianapolis, IN (US)

Correspondence Address: LAW OFFICES OF MICHAEL DRYJA, 1474 N COOPER RD #105-248, GILBERT, AZ, 85233, US

(73) Assignee: QUADTRI TECHNOLOGIES, LLC, Lithonia, GA (US)

(21) Appl. No.: 12/039,464

(22) Filed: Feb. 28, 2008

Related U.S. Application Data
(60) Provisional application No. 60/903,867, filed on Feb. 28, 2007.

(51) Int. Cl. B41J 5/00

(52) U.S. Cl. 400/489

(57) ABSTRACT

A device includes a keyboard mechanism having a number of keys, where the keyboard mechanism individually discerns typing of each key. The keyboard mechanism defines a keyboard layout of the keys. The keyboard layout is adapted to touch-typing by a user using a single hand. The keyboard layout has a sub-number of the keys of the keyboard mechanism organized over a number of columns within a center portion of the keyboard layout. The columns are organized around an imaginary vertical line running through the center portion of the keyboard layout. The sub-number of the keys are larger in size than a majority of other keys of the keyboard mechanism.

### RELATED PATENT APPLICATIONS

The present patent application claims priority to and the benefit of the previously filed provisional patent application entitled “One handed mobile keyboard layout,” filed on Feb. 28, 2007, assigned Ser. No. 60/903,867, and which in its entirety is hereby incorporated by reference.

### BACKGROUND

Mobile devices are increasing in popularity. Such mobile devices include personal-digital assistance (PDA) devices, telephony devices like mobile phones, other types of communications device, audio and/or video devices like portable music and/or video players, as well as other types of mobile devices. In many types of such devices, a user may often have to enter textual input at times. For example, a user may wish to compose and send a text message using such a mobile device, or may wish to enter text while browsing the Internet using such a mobile device.

Due to their relatively small size, however, mobile devices are generally not adept at permitting users to enter textual input with efficiencies that are anywhere near more non-mobile devices like laptop and desktop computers. For example, while desktop computers typically are equipped with full-sized keyboards permitting users to touch-type using both hands, and while laptop computers usually are equipped with full-sized or slightly smaller keyboards that still nevertheless permit users to touch-type using both hands, mobile devices inherently are not. As a result, entering textual input on a mobile device can be painstakingly slow, and/or be prone to significantly more input errors than as compared to a typical desktop or laptop computer.

For these and other reasons, there is a need for the present invention.

### SUMMARY

A device of one embodiment of the invention includes a keyboard mechanism and a keyboard layout. The keyboard mechanism includes a number of keys, and individually discerns typing of each key. The keyboard layout of the keys is defined by the keyboard mechanism, and is adapted to touch-typing by a user using a single handed.

The keyboard layout has a sub-number of the keys organized over a number of columns within a center portion of the keyboard layout, and/or over an odd number of rows having a center row. The columns are organized around an imaginary vertical line running through the center portion of the keyboard layout. The center row where present may be a home position of the keys of the keyboard mechanism upon which non-thumb fingers of the single hand of the user are to rest in-between keystrokes.

The sub-number of the keys are larger in size than a majority of other keys of the keyboard mechanism. For instance, the sub-number of the keys may be wider, taller, and/or have greater surface areas than the majority of the other keys. The pitch between horizontally adjacent of the sub-plurality of the keys of the keyboard mechanism may be at least sixteen millimeters, whereas the pitch between horizontally adjacent of the majority of the other keys of the keyboard mechanism may be less than sixteen millimeters. The keys may comprise individual keys for each letter of the alphabetic, as well as for each number between one and zero (inclusive). As such, the user depresses a single key to enter any number or a lower-case version of any letter.

Still other aspects and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a perspective view diagram of a representative device, according to an embodiment of the invention.

FIG. 2 is a block diagram of a representative device, according to an embodiment of the invention.

FIG. 3 is a diagram of an exemplary keyboard layout for the keys of a keyboard of a device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

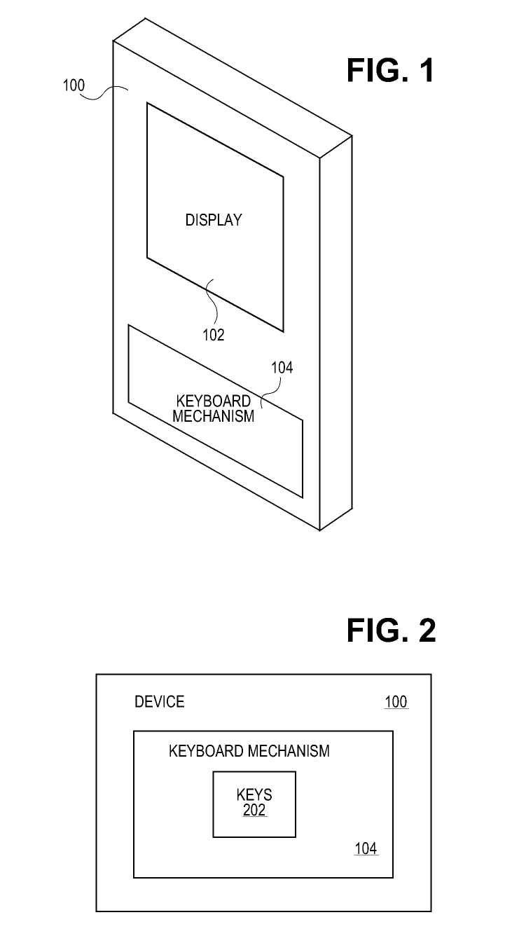

FIGS. 1 and 2 show a perspective view diagram and a block diagram, respectively, of a device 100, according to an embodiment of the invention. The device 100 may be a mobile device, which may generally and non-restrictively defined as a device that is normally held in one hand while being used. Such mobile devices can include personal-digital assistance (PDA) devices, telephony devices like mobile phones, other types of communications device, audio and/or video devices like portable music and/or video players, as well as other types of mobile devices.

The device 100 is depicted in FIGS. 1 and 2 as including a display 102 and a keyboard mechanism 104 having a number of keys 202. Those of ordinary skill within the art can appreciate that the device 100 may and typically does have a number of additional components, in addition to and/or in lieu of the keyboard mechanism 104 and the display 202. The display 102 itself may be a flat-panel display, such as a liquid-crystal display (LCD), an organic light-emitting display (OLED), or another type of flat-panel display.

The keyboard mechanism 104 in general is able to individually discern typing of each of the keys 202. That is, the keyboard mechanism 104 is able to determine when each of the keys 202 has been depressed. For example, the keyboard mechanism 104 is able to determine that a given key has been typed, as opposed to a key other than this given key.

The keyboard mechanism 104 may implement the keys 202 as individual physical keys. In this embodiment, the keyboard mechanism 104 may be considered as being separate to the device 100. Each of the keys 202 in this embodiment may include a switching mechanism that registers when the key has been depressed. Such a switching mechanism may be a membrane-type mechanism, a buckling spring-type mechanism, or another type of mechanism, as can be appreciated by those of ordinary skill within the art

In other embodiment, the keyboard mechanism 104 may implement the keys 202 as virtual keys. Virtual keys are keys that are not physical keys, and thus typically do not have switching mechanisms that register their being depressed. As one example, in such an embodiment, the keyboard mechanism 104 may be part of or may include the display 102. At least a portion of the display 102 may be a touch-sensitive display. Thus, the keys 202 are displayed as graphics or images on the display 102, such that pressing a part of the display 102 corresponding to a given key results in the key having been typed.

Those of ordinary skill within the art can appreciate that the keyboard mechanism 104 can be implemented in any of a number of other ways as well. For example, one type of keyboard mechanism projects the display of a virtual keyboard having virtual keys 202 onto an external and typically flat surface. Such a keyboard mechanism is able to discern when a user has “typed” a given key projected on this flat surface.

In one embodiment, the device 100 may just be an external keyboard device for communicative connection to another device in a wired and/or a wireless manner. For example, such an external keyboard device may communicate with a (different) mobile device, to provide the latter device with a particular way by which textual entry can be achieved into the device via the keyboard mechanism 104 of the external keyboard device 100. Of course, the device 100 may alternatively be a mobile device that has the keyboard mechanism 104 integrated therewithin.

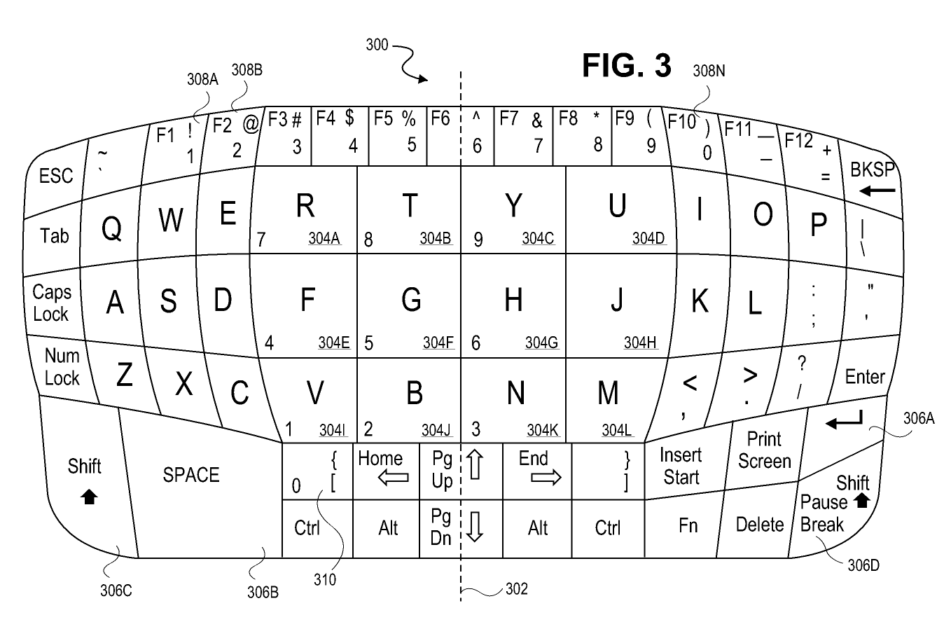

FIG. 3 shows a keyboard layout 300 for the keys 202 of the keyboard mechanism 104, according to an embodiment of the invention. It can be said that the keyboard layout 300 is defined by the keyboard mechanism 104, in that the locations and sizes of the keys 202 are specified by the keyboard mechanism 104. The keyboard layout 300 is generally adapted for touch-typing by a user using a single hand.

Touch-typing may be generally defined as typing without using the sense of sight to find the keys. Standard touch-typing, such as using a regular full-size keyboard of a desktop computer, or a full-size or a smaller keyboard of a laptop computer, involves using both hands. By comparison, the keyboard layout 300 is adapted for touch-typing using a single hand, as is described in more detail later in the detailed description.

The keyboard layout 300 as depicted in FIG. 3 is organized in a QWERTY manner, in that the letters are organized in a QWERTY fashion as known to those of ordinary skill within the art. The QWERTY manner in which the keyboard layout 300 is organized is specifically for one-handed touch-typing by the right-hand of the user. A left-handed embodiment, by comparison, may involve reversing the letters of each row, such that instead of the letters Q, W, E, R, T, Y, U, I, O, and P being positioned from left to right on the first row, these letters may be organized from right to left on the first row.

In another embodiment, the keyboard layout 300 may be organized in a DVORAK manner, in that the letters are organized in a DVORAK fashion as known to those of ordinary skill within the art. As before, the keyboard layout 300 may be organized for right-handed or left-handed touch-typing by the user. In other embodiments, the keys of the keyboard layout 300 may be organized in a manner other than a QWERTY or a DVORAK manner.

The keyboard layout 300 includes keys 304A, 304B, 304C, 304D, 304E, 304F, 304G, 304H, 304I, 304J, 304K, and 304L, collectively referred to as the keys 304. The keys 304 are organized over four columns and over three rows within a center portion of the keyboard layout 300. The columns are organized symmetrically around an imaginary vertical line 302 running through the center portion of the keyboard layout, although in another embodiment, they may be organized asymmetrically around the imaginary vertical line 302. The three rows include a center row, which can be considered the home position of the keys, upon which non-thumb fingers of the user's single hand rest in-between keystrokes while touch-typing with this hand.

The keys 304 are larger in size than a majority of the other keys. For example, in the embodiment of FIG. 3, the keys 304 are larger than all the keys except for the keys 306A, 306B, 306C, and/or 306D, collectively referred to as the keys 306. In one embodiment, the keys 304 are substantially equal in size to the keys of a regular, full-sized desktop computer keyboard, or at least to the keys of a regular, smaller-sized laptop computer keyboard, as can be appreciated by those of ordinary skill within the art. For instance, the pitch between horizontally adjacent of the keys 304 may be at least sixteen millimeters, while the pitch between horizontally adjacent of the majority of other keys may be less than sixteen millimeters.

The keys 304 may be larger in size than the majority of the other keys in one or more of three different ways. First, they may be wider from left to right than these other keys. Second, the keys 304 may be taller from front to back than these other keys. Third, the keys may each have a greater surface area than each of these other keys.

By making the keys 304 larger than the majority of the other keys, the majority of the other keys can be reduced in size so that the entire keyboard layout 300 can fit within a typical mobile device 100, which usually fits within a single hand of a user and can be grasped between the user's thumb and the user's ring or pink finger. In this way, the user can use a single hand to touch-type on the keyboard. Because the keyboard layout 300 is organized in one embodiment for at least the most part in standard QWERTY fashion, the user does not have to learn a new layout in order to touch type, and just has to become familiar with using just one hand to touch type, instead of both hands.

It is noted that the keys 304 are part of a larger group of keys corresponding to the letters of the alphabet. Thus, there is a separate key for each letter of the alphabet. The user just has to depress a single key, therefore, to enter a given (lower-case) version of a particular letter. This compares to other types of one-handed keyboards, in which at least some of the letters requires a user to press one or more keys—either at the same type or sequentially—to enter a given letter. Likewise, there are keys 308A, 308B, . . . , 308N, corresponding to the numbers between one and zero, such that there is a separate key for each number, and such that the user just has to depress a single key to enter a given number between one and zero.

As depicted in FIG. 3, there are also individual keys for enter or return, space bar, backspace, escape, tab, caps-lock, num-lock, print-screen, and delete. There are in FIG. 3 a number of individual shift keys, a number of individual cursor keys, a number of individual control keys, a number of individual alt keys, and a number of individual punctuation keys as well. To enter an upper-case letter, or a shifted version of a key (e.g., the symbol “@” on the number two key, and other punctuation marks for the other number keys), the shift key can be used in different ways in different embodiments of the invention.

First, as in a standard keyboard, one of the shift keys may have to be depressed and held down while the desired key is being depressed to enter the shifted version of the desired key. Thus, a user holds down the shift key and then depresses the number two key to enter the symbol “@”. However, this may be difficult to accomplish with just one hand.

Therefore, second, a user may be able to depress and released one of the shift keys, and thereafter depress (and subsequently release) the desired key to enter the shifted version of the desired key. Thus, a user depresses and releases the shift key, and then depresses the number two key to enter the symbol “@”. This approach may be more easily accomplished with just one hand.

To facilitate entry of numbers, the keyboard layout 300 provides for a num-lock mode that is entered into and exited from by successive depressings of the num-lock key. While in num-lock mode, depressing and releasing any of the keys 304A, 304B, 304C, 304E, 304F, 304G, 304I, 304J, 304K, and 310 results in the entry of the numbers 7, 8, 9, 4, 5, 6, 1, 2, 3, and 0, respectively. Therefore, while the basic size of the keyboard layout 300 precludes the inclusion of a separate numeric keypad, the num-lock mode nevertheless permits a user to use the keyboard layout 300 as if it had a separate numeric keypad.

The layout of the keys and the general sizes of the keys within the keyboard layout 300 advantageously permits more easily achieved one-handed touch-typing by a user. Competing keyboard layouts generally require users to learn new ways in which the keys are organized, while the keys within the keyboard layout 300 are organized in at least a substantially QWERTY manner. The user still has a home position to rest his or her non-thumb fingers, in that the keys 304E, 304G, 304G, and 304H (along with the other of the keys 304) are at least substantially full-sized, no different than on a regular desktop computer keyboard or a laptop computer keyboard. Nevertheless, touch-typing with just a single hand is afforded by the majority of the other keys of the keyboard layout 300 being smaller in size (by width, height, and/or surface area) than the keys 304 are. Thus, an existing touch-typist can more quickly get up to speed on learning how to touch-type with the keyboard layout 300 with just one hand, because he or she does not have to learn a completely new way to type.

The keys 304 may be different than the majority of the other keys in other ways as well. First, the top surface of each of the keys 304 may be different than the top surface each of the majority of the other keys. For example, the top surfaces of the keys 304 may be convex, while the top surfaces of the majority of the other keys may be concave, or vice-versa. As another example, the top surfaces of the keys 304 may have a particular texture, while the top surfaces of the majority of the other keys may have a different particular texture. As a third example, the top surfaces of the keys 304 may be sloped in a particular way (e.g., downwards from top to bottom), while the top surfaces of the majority of the other keys may be sloped in a different particular way (e.g., downwards from bottom to top). In general, it can be said that in such embodiments, the top surface of each of the keys 304 is concave, convex, sloped in a first particular way, and/or has a first texture, while the top surface of each of the majority of the other keys is concave, convex, sloped in a second particular way, and/or has a second texture.

Second, the keys 304 may be different than the majority of the other keys in other ways as well in that the height of the keys 304 along the z-axis along which the keys are depressed by the user may be different than the height of the majority of the other keys along the z-axis along which the keys are depressed. The z-axis is the axis perpendicular to the plane of FIG. 3, for instance. A user depresses a given key by pushing the key downwards into the plane of FIG. 3, as can be appreciated by those of ordinary skill within the art. Thus, the keys 304 may each have a height along this z-axis that is greater than or less than the height of each of the majority of the other keys along this z-axis.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

We claim:

1. A device comprising:
a keyboard mechanism having a plurality of keys, the keyboard mechanism to individually discern typing of each key; and,
a keyboard layout of the keys defined by the keyboard mechanism, the keyboard layout adapted to touch-typing by a user using a single hand,
wherein the keyboard layout has a sub-plurality of the keys of the keyboard mechanism organized over a plurality of columns within a center portion of the keyboard layout, the columns organized around an imaginary vertical line running through the center portion of the keyboard layout, and
wherein the sub-plurality of the keys are larger in size than a majority of other keys of the keyboard mechanism.

2. The device of claim 1, wherein the keyboard layout is at least substantially organized in a QWERTY manner, for one-handed touch-typing by one of a left hand and a right hand of the user.

3. The device of claim 1, wherein the keyboard layout is at least substantially organized in a DVORAK manner, for one-handed touch-typing by one of a left hand and a right hand of the user.

4. The device of claim 1, wherein the sub-plurality of the keys of the keyboard mechanism are further organized over an odd number of rows having a center row.

5. The device of claim 4, wherein the center row is a home position of the keys of the keyboard mechanism upon which non-thumb fingers of the single hand of the user are to rest in-between keystrokes.

6. The device of claim 1, wherein the sub-plurality of the keys of the keyboard mechanism are larger in size than the majority of the other keys of the keyboard mechanism in that the sub-plurality of the keys are wider than the majority of the other keys.

7. The device of claim 1, wherein the sub-plurality of the keys of the keyboard mechanism are larger in size than the majority of the other keys of the keyboard mechanism in that the sub-plurality of the keys are taller than the majority of the other keys.

8. The device of claim 1, wherein the sub-plurality of the keys of the keyboard mechanism are larger in size than the majority of the other keys of the keyboard mechanism in that the sub-plurality of the keys each has a greater surface area than each of the majority of the other keys.

9. The device of claim 1, wherein a pitch between horizontally adjacent of the sub-plurality of the keys of the keyboard mechanism is at least sixteen millimeters.

10. The device of claim 9, wherein a pitch between horizontally adjacent of the majority of the other keys of the keyboard mechanism is less than sixteen millimeters.

11. The device of claim 1, wherein a top surface of each of the sub-plurality of the keys is different than a top surface of each of the majority of other keys of the keyboard mechanism.

12. The device of claim 11, wherein the top surface of each of the sub-plurality of the keys is one or more of: of concave, convex, sloped in a first particular way, and having a first texture, and the top surface of each of the majority of other keys of the keyboard mechanism is a different one or more of: concave, convex, sloped in a second particular way, and having a second texture.

13. The device of claim 1, wherein the sub-plurality of the keys have a height along a z-axis along which the keys are depressed by the user that is different than a height of a majority of other keys of the keyboard mechanism along the z-axis along which the keys are depressed by the user.

14. The device of claim 1, wherein the keys of the keyboard mechanism comprise individual keys for:
each of all letters of the alphabet; and,
each of all numbers between one and zero,
such that the user depresses a single key to enter any number or a lower-case version of any letter.

15. The device of claim 1, wherein the keys of the keyboard mechanism are individual physical keys.

16. The device of claim 1, wherein the keys of the keyboard mechanism are virtual keys.

17. The device of claim 1, wherein the device is one or more of: a mobile device, a personal-digital assistance (PDA) device, a telephony device, a communications device, and an audio and/or video device.

18. The device of claim 1, wherein the device is an external keyboard device for another device to communicatively connect in a wired and/or a wireless manner with the other device.

19. A device comprising:
means for individually discerning type of each key of a plurality of keys; and,
a keyboard layout of the keys defined by the keyboard mechanism, the keyboard layout adapted to touch-typing by a user using a single hand,
wherein the keyboard layout has a sub-plurality of the keys of the keyboard mechanism organized over a plurality of columns within a center portion of the keyboard layout, the columns organized around an imaginary vertical line running through the center portion of the keyboard layout, and
wherein the sub-plurality of the keys are larger in size than a majority of other keys of the keyboard mechanism.

20. A device comprising:
a keyboard mechanism having a plurality of keys, the keyboard mechanism to individually discern typing of each key; and,
a keyboard layout of the keys defined by the keyboard mechanism, the keyboard layout adapted to touch-typing by a user using a single hand,
wherein the keyboard layout has a sub-plurality of the keys of the keyboard mechanism organized over a plurality of columns within a center portion of the keyboard layout and over an odd number of rows having a center row, the columns organized around an imaginary vertical line running through the center portion of the keyboard layout,
wherein the sub-plurality of the keys are larger in size than a majority of other keys of the keyboard mechanism in that the sub-plurality of the keys are wider, taller, and/or have greater surface areas than the majority of the other keys,
wherein a pitch between horizontally adjacent of the sub-plurality of the keys of the keyboard mechanism is at least sixteen millimeters, and a pitch between horizontally adjacent of the majority of the other keys of the keyboard mechanism is less than sixteen millimeters, and
wherein the keys of the keyboard mechanism comprise individual keys for:
each of all letters of the alphabet; and,
each of all numbers between one and zero,
such that the user depresses a single key to enter any number or a lower-case version of any letter.
